(19) United States
(12) Patent Application Publication
(10) Pub. No.: US 2021/0114848 A1
(43) Pub. Date: Apr. 22, 2021

(54) CANTILEVERED LIFTING BEAM SYSTEM

(71) Applicant: IRVING LICENSING INC., Saint John (CA)

(72) Inventors: Ryan Long, Saint John (CA); Todd Cusack, Saint John (CA); Julien Raby, Saint John (CA)

(21) Appl. No.: 17/038,257

(22) Filed: Sep. 30, 2020

(30) Foreign Application Priority Data
Oct. 1, 2019 (CA) 3057196

(51) Int. Cl. B66C 23/32; B66C 1/10; B66C 23/72

(52) U.S. Cl. CPC B66C 23/32; B66C 23/72; B66C 1/105

(57) ABSTRACT

Described herein is a lifting beam system and method for using the same. The lifting beam system includes an elongate platform, a block, and a first and second cable for suspending the elongate platform from the block. The block for connecting the lifting beam system to a lifting device. The length of the second cable extending between the elongate platform and the block being adjustable by a winch. By adjusting the length of the second cable, the elongate platform may be leveled after a load is applied to one end of the elongate platform.

### CROSS-REFERENCE TO RELATED PATENT APPLICATION

This application claims priority from Canadian Patent Application No. 3,057,196 filed on Oct. 1, 2019. The contents of the foregoing is hereby incorporated by reference.

### TECHNICAL FIELD

Various embodiments described herein relate to systems and methods for lifting a load, and in particular to lifting systems and methods for cranes and the like.

### INTRODUCTION

Lifting devices such as cranes are widely used throughout industries such as the construction and transport industries. In particular, cranes may be used for moving objects to and/or from locations that may not be readily accessible to other machinery. Although most lifting devices perform similar lifting functions, there is a wide variety of lifting devices as they can be modified or designed to perform specific tasks.

Lifting device accessories (sometimes called a below the hook lifting device) can also be designed to have unique features that allow them to perform specific tasks. Such accessories may be designed for a particular lifting device, or may be designed to be used with various types of lifting devices.

### SUMMARY

This summary is intended to introduce the reader to various aspects of the applicant's teaching, but not to define any specific embodiments. In general, disclosed herein are one or more lifting beam systems and methods for using a lifting beam system to lift an object.

In a first aspect, some embodiments provide a lifting beam system securable to (or suspendable from) a lifting device. The system can include an elongate platform extending between a first end region and a second end region, the elongate platform being connected to a block by a first cable and a second cable. The block may be operable for connecting the lifting beam system to the lifting device. The first cable may extend between the block and a central region of the elongate platform, and the second cable may extend between the block and the first end region of the elongate platform. In some examples, a length of the second cable that extends between the block and the elongate platform is adjustable for varying the distance between the block and the first end region of the elongate platform.

In some embodiments, the elongate platform includes a winch for adjusting the length of the second cable that extends between the block and the elongate platform. The winch may or may not be connected to a top surface of the platform.

In some embodiments, the elongate platform includes a first pulley at the first end region of the elongate platform, with the second cable extending between the block and the first pulley and between the first pulley and the winch. In some cases, wherein the winch is located proximate to the central region of the elongate platform.

In some cases, the block comprises a block pulley. The second cable may extend between the block pulley and the elongate platform.

In some cases, the elongate platform includes a second pulley. The second cable may extend from the second pulley to the block.

In some examples, the platform comprises a first elongate platform laterally spaced from a second elongate platform, with the first elongate platform connected to the second elongate platform one or more removable crosspieces.

In some cases, the lateral space between the first and second members is adjustable. In some cases, the lateral space between the first and second members is adjustable by exchanging at least one of the at least a first crosspieces with an alternate crosspiece.

In some examples, the winch is connected to one of the at least a first crosspieces.

In some examples, the elongate platform includes a mount at the first end region for receiving a counter weight, with the second cable connecting to the elongate platform between the mount and the central region.

In some examples, the elongate platform comprises a mount at a second end of the elongate platform, the mount for receiving a load.

### BRIEF DESCRIPTION OF THE DRAWINGS

Various embodiments will now be described in detail with reference to the drawings, in which:

FIG. 1A is a side view of a lifting beam system in an unloaded position;

FIG. 1B is a side view of the lifting beam system of FIG. 1A in a loaded position;

FIG. 2 is a perspective view of the elongate platform of the lifting beam system of FIG. 1A;

FIG. 3A is a schematic plan view of a lifting device and cantilevered lifting beam found in the prior art;

FIG. 3B is a schematic plan view of a lifting device and another example of a lifting beam system of FIG. 1A.

### DESCRIPTION OF EXEMPLARY EMBODIMENTS

Various apparatuses, and/or methods will be described below to provide exemplary embodiments. No embodiment described below limits any claims and any claims may cover apparatuses or methods that differ from those described below. The claims are not limited to apparatuses or methods having all of the features of any one apparatus or method described below or to features common to multiple or all of the apparatuses described below. It is possible that an apparatus or method described below is not an embodiment of any claims.

Any apparatus or method described below that is not claimed in this document may be the subject matter of another protective instrument, for example, a continuing patent application, and the applicants, inventors or owners do not intend to abandon, disclaim or dedicate to the public any such apparatus of method by its disclosure in this document.

An example of a lifting device accessory that may be used with various types of lifting devices is a cantilevered lifting beam. Unlike simple hook mechanisms that can normally only be dropped into a location from above that location, a cantilevered lifting beam can reach into a space that is not accessible from above. Cantilevered lifting beams can also be designed to remain level (or at a specific angle) during loading and unloading of an object to be transported.

Typically, to remain level (or at a selected angle), cantilevered lifting beams use a moveable counter weight system that can offset the forces generated by an applied load. For example, consider a beam suspended in the middle by a cable, i.e., a cantilevered beam. If a load is applied to one end of that beam, a moment will be created at the middle of the beam, where it is connected to the cable, causing the beam to rotate. If an equally sized load, i.e., a counter weight, is applied to the other end of the beam, a second moment will be created at the middle of the beam that is equal but opposite in magnitude to the first moment. The first and second moments being equal in magnitude but opposite in direction with therefore cancel each other out. When the moments cancel each other in this way, the beam will remain level. However, a problem occurs when the first load is removed as the counter weight itself will cause the beam to rotate.

A moveable counter weight system may be used to address this problem as the counter weight can be repositioned according to the loaded and unloaded state of the system. Put another way, a cantilevered lifting beam can be designed such that in an unloaded state with counter weight in a first position the system may be balanced, and in a loaded state with the counter weight in a second position, the system may also be balanced. Moveable counter weights also allow systems to lift successive loads of varying weight without requiring structural modifications to the lifting device between loads as the counter weight can be positioned such that the system remains level.

An example of a lifting beam with a moveable counter weight system is described in U.S. Pat. No. 4,671,721 to Pratt et al. (“Pratt”). The device taught by Pratt is designed to lift precast concrete panels to a desired opening in a building under construction. To compensate for the weight of the panel, i.e., to negate the moment generated by the precast concrete panel load, Pratt teaches an apparatus having a moveable counter weight that rolls back and forth the length of the apparatus.

In addition to the moveable counter weight, Pratt describes a drum and cable system that allows for fine leveling of the frame once the panel is substantially in place. Specifically, Pratt describes rotating the drum to shorten the length of cable which pulls the rear of the frame upwards. In a similar manner, by releasing cable from the drum, the rear of the frame may be lowered. Pratt teaches the cable and drum system to allow for fine adjustments of the frame.

A counter weight system such as that described by Pratt may quickly become unable to perform a task due to the large amount of force that may act on the lifting device generated by both the counter weight and the load. As a simple example, to lift an object having a mass M1 a horizontal distance L1 from the crane tower, the counter weight will: (1) have a mass M2 greater than M1 and be moveable a horizontal distance L2 (L2=(M1/M2)L1) from the crane tower (L2<L1); (2) have a mass M2 equal to M1 and be moveable a distance L2 equal to L1 from the crane tower; or (3) have a mass M2 being less than M1 and be moveable a distance L2 (L2=(M1/M2)L1) from the crane tower (L2>L1).

Put another way, if the system is to reach a substantial distance into a space, the counter weight may end up weighing more than the object to be moved or the system will be capable of moving the counter weight a more than a substantial distance away from the suspension point of the beam.

If the counter weight weighs more than the object to be moved, the mass of the object to be moved becomes limited as the total weight of the object and counterweight may become too great for other components of the lifting system, for example the hook, the cable, the lifting mechanism, i.e., winch, or for the lifting device itself.

If, on the other hand, the counter weight weighs less than the object to be moved, the lifting beam will be very long to allow the counter weight to be moved the necessary distance away from the suspension point. As the beam becomes longer to accommodate the movement of the counter weight, the beam may become difficult to maneuver.

Accordingly, some cantilevered lifting beam systems have removed the moveable counter weight mechanism, for example the Barnhart Dual Line Cantilevered Beam system (the “Barnhart system”) (https://www.barnhartcrane.com/markets/rigging-solutions/). The Barnhart system uses two load lines that each extend from the lifting device to a bear-paw, and from the bear-paw to the cantilevered lifting beam. The system also uses a fixed counter weight attached to the beam to offset a portion of the moment created by an applied load.

The main line, as taught by Barnhart, has a fixed length and the auxiliary line has an adjustable length. By adjusting the length of the auxiliary line, an operator of the system can adjust the location of the center of gravity of the system. Therefore, if a load is applied to a distal end of the cantilevered lifting beam, the auxiliary line can be adjusted such that the center of mass of the system translates to below the bear-paw which levels the beam.

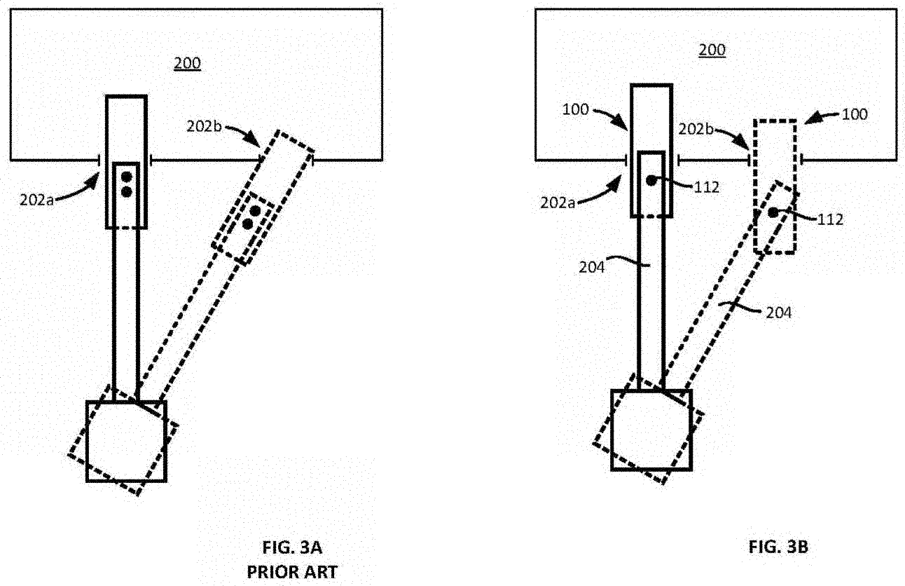

Using two load lines extending from the lifting device limits the risk of the beam tipping due to instability. However, using two load lines also prevents the system from rotating about the lifting device. Put another way, the cantilevered lifting beam in such a system must remain in-line with the lifting device, as is exemplified in FIG. 3A.

The present embodiments set out to address some of the problems identified with earlier approaches, and teach cantilevered lifting beam systems having an optional fixed counter weight and a single load line.

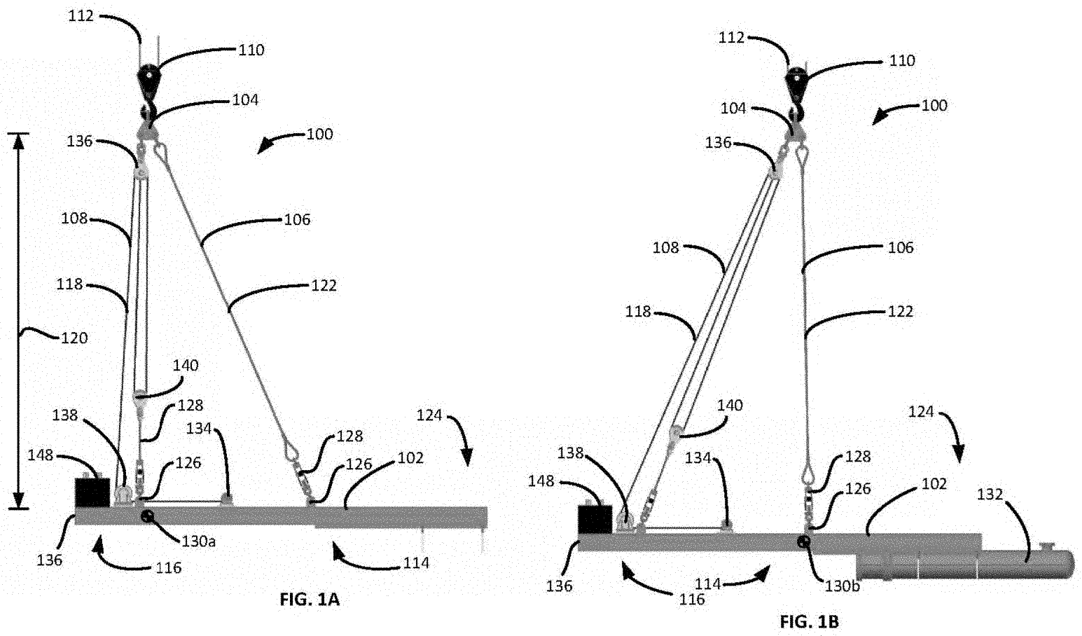

Referring now to FIG. 1A, a lifting beam system 100 is shown having an elongate platform 102, a block 104, a first cable 106, and a second cable 108. The elongate platform 102 extends between a first end 116 and a second end 124.

In the example illustrated, the elongate platform includes a mount at a second end 124 of the elongate platform 102 for receiving a load 132. The first and second cables 106, 108 extend between the elongate platform 102 and the block 104 to suspend the elongate platform 102 from the block 104.

In the example illustrated, the block 104 is suspended from a hook 110 that is supported by a main hoist line 112 that may extend to a lifting device, e.g., a crane (not shown) as will be readily understood by a person of ordinary skill in the art. In some examples, the block 104 may not be suspended from a hook, and rather, suspended from a second block. In other examples, the block 104 may be directly coupled to the main hoist line 112.

Still referring to FIG. 1A, the first cable 106 extends between the elongate platform 102 and the block 104 to connect the elongate platform 102 to the block 104. In the example illustrated, the first cable 106 extends from the block 104 to a central region 114 of the elongate platform 102. The second cable 108 also extends between the block 104 and the elongate platform 102 to connect the elongate platform 102 to the block 104. In the example illustrated, the second cable 108 extends from the block 104 to a first end region 116 of the elongate platform 102.

A length 118 of the second cable 108 that extends between the block 104 and the elongate platform 102 is adjustable. The length 118 of the second cable 108 may be adjustable for varying the distance between the block 104 and the first end region 116 of the elongate platform 102. In the example illustrated, the second cable 108 is shown to pass through multiple pulleys.

By passing through multiple pulleys the length 118 of the second cable 108 that extends between the block 104 and the elongate platform 102 is greater than a linear distance 120 between the elongate platform 102 and the block 104.

In other examples, the length 118 of the second cable 108 that extends between the block 104 and the elongate platform 102 may be substantially similar to the linear distance 120. In an example where the length 118 and the linear distance 120 are substantially similar, there may not be any pulleys acting on the second cable 108.

In other examples, a single pulley or two pulleys may be used, and in yet other examples, more than 3 pulleys may be used to guide the second cable 108 as it extends between the block 104 and the elongate platform 102.

The length 118 of the second cable 108 is generally adjustable to allow the location of the center of gravity 130 of the lifting beam system 100 to translate along the elongate platform 108. It may be desirable to adjust the location of the center of gravity 130 when a load 132 is applied to a second end 124 of the elongate platform 102 as this may allow the elongate platform to remain level (or at a particular angle).

In the example illustrated, the center of gravity 130 of the lifting beam system is shown on the elongate platform 102, however, as the lifting beam system 100 includes the first and second cables 106, 108 and the block 104, in actuality, the center of gravity 130 may be above the elongate platform 102. The graphical representation of the center of gravity 130 is meant to aid in this description and is not meant to show the exact location of the center of gravity 130.

In the example illustrated, referring to FIG. 1A, the lifting beam system 100 is shown in an unloaded state. In the unloaded state, the center of gravity 130a of the lifting beam system 100 may be in the first end region 116 proximate the location the second cable 108 connects to the elongate platform 102 underneath the block 104. In other examples, the center of gravity 130a of the lifting beam system 100 in the unloaded state may not be located proximate the location the second cable 108 connects to the elongate platform 102.

Referring now to FIG. 1B, the lifting beam system is shown in a loaded state. In the loaded state, the center of gravity 130b is located in the central region 114 proximate the location the first cable 106 connects to the elongate platform 102. As demonstrated in FIG. 1B, the center of gravity 130b is underneath the block 104. Put another way, the block 104 and the center of gravity 130 translate substantially concurrently. In other examples, the center of gravity 130b may not be proximate the location the first cable 106 connects to the elongate platform 102 when in the loaded state.

In order for the center of gravity 130 to translate along the elongate platform 102 from 130a to 130b, and for the elongate platform to remain level (or at a particular angle), the length 118 of second cable 108 may be extended. In order for the center of gravity 130 to translate along the elongate platform 102 from 130b to 130a, and for the elongate platform to remain level, the length 118 of the second cable 108 may be reduced.

In the example illustrated, a length 122 of the first cable 106 may remain substantially uniform when transitioning between the unloaded and loaded states. In other examples, the length 122 of the first cable 106 may be adjustable. In an example where the length 122 of the first cable 106 is also adjustable, rather than shortening the length 118 of the first cable 108 to shift the center of gravity 130b to 130a, the length 122 of the first cable may be extended to allow the elongate platform 102 to remain level.

In the example illustrated, the elongate platform may include a tab 126 and tether 128 (also sometimes called a lug and shackle) for connecting the first cable 108 to the elongate platform. The elongate platform 102 may also include a second tab 126 and a second tether 128 for connecting one pulley of the series of pulleys to the elongate platform 102. In other examples, the elongate platform may include any number of tabs and tethers used to connect features of the lifting beam system 100 to the elongate platform 102.

Still referring to FIGS. 1A and 1B, in the example illustrated, the elongate platform may include a winch 134 that may be used to adjust the length of the first cable. Although the winch 134 is shown to be positioned proximate the central region 114, in other examples this may not be the case.

For example, in some embodiments, there may not be a system of pulleys, and the winch 134 may be located proximate the first end region 116. In another example, the winch 134 may be positioned proximate a distal edge 136 of the elongate platform 102. In the example illustrated, the winch 134 is connected to a top surface of the elongate platform 102, however, in other examples, the winch may located proximal the elongate platform 102.

The winch 134 may be any type of device that allows for the second cable 108 to be pulled in and let out. For example, the winch may be an electric winch, a lever winch, a snubbing winch, an air winch, a capstan winch, a mooring winch, a mechanical drum winch, a hydraulic drum winch, etc.

The winch may be controlled remotely by an operator. For example, an operator may be located on the ground, on the lifting device, or in a nearby building. The control signals may be either wireless or wired. In another example, the winch may be automatic. That is, a control system may determine if the elongate platform 102 is level or not (or at a particular angle or not), and signal the winch to let out cable, pull in cable, or remain stationary based on the position of the elongate platform 102.

As mentioned above, the lifting beam system 100 may include a series of pulleys. The lifting beam system 100 may include pulleys to reduce the amount of force required by the winch 134 to adjust the length 118 of the second cable 108.

In the example illustrated, the block 104 includes a block pulley 136, and the elongate platform 102 includes a first pulley 138 at the first end region 116, and a second pulley 140 intermediate the winch 134 and the first pulley 138. Accordingly, the second cable 108 is shown to extend between the winch 134 and the first pulley 138, between the first pulley 138 and the block pulley 136, between the block pulley 136 and the second pulley 140, and between the second pulley 140 and the block 104.

In other examples, there may only be the first pulley 138. In this example, the second cable 108 would extend between the winch 134 and the first pulley 138 and between the first pulley 138 and the block 104. In another example, there may only be the first pulley 138 and the block pulley 136. In this example, the second cable 108 would extend between the winch 134 and the first pulley 138, between the first pulley 138 and the block pulley 136, and between the block pulley 136 and the elongate platform 102. In yet another example, there may be more than three pulleys.

In another example, there may not be any pulleys. In this example, the winch 134 may be located proximate the location the first pulley 138 is shown to be in FIGS. 1A and 1B. In this example, the second cable 108 would extend between the winch 138 and the block 104. In yet another example, the winch may be located proximate the location the first pulley 138 is shown to be in FIGS. 1A and 1B and the lifting beam system 100 may include a series of pulleys.

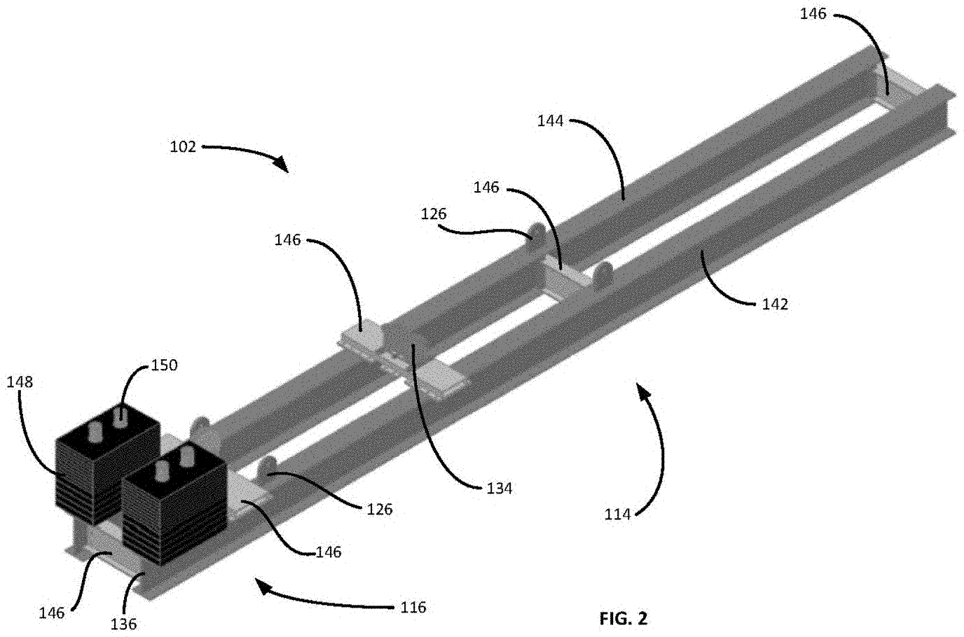

Referring now to FIG. 2, in the example illustrated, the elongate platform includes a first elongate member 142 and a second elongate member 144 laterally spaced from the first elongate member 142. The first and second elongate members 142, 144 are connected by at least one removable crosspiece 146. In other examples, the elongate platform 102 may be a single elongate member, and in other examples, there may be more than two elongate members that form the elongate platform 102. In examples where a single elongate member forms the elongate platform 102, the elongate platform may be of any shape or form.

In the example illustrated, the first elongate member 142 is shown to extend substantially in-line with the second elongate member 144. In other examples, the second elongate member 144 may not extend substantially in-line with the first elongate member 142. For example, the first and second elongate member 142, 144 may form a V shape. In other examples where there are more than two elongate members any shape may be formed by the elongate members.

The at least one removable crosspiece may be disconnected from the elongate members 142, 144 and be exchanged for at least one larger or smaller crosspiece, i.e., an alternative crosspiece. The elongate platform 102 formed by the elongate members 142, 144 and the at least one crosspiece may therefore be adjustable to accommodate the load it is being used to transport.

In the example illustrated, the winch 134 is shown to connect to at least one of the crosspieces connecting the first elongate platform 142 to the second elongate platform 144. In other examples, the winch may be connected to more than one crosspieces or may be connected to one of the first and second elongate members 142, 144.

Referring still to FIG. 2, in the example illustrated, the elongate platform 102 includes a mount 150 for receiving a counter weight 148. Although the mount 150 is shown in FIGS. 1A-2 to extend from a top side of the distal end 136 of the elongate platform 102, in other examples the mount 150 may not be located in this position. For example, the mount 150 may extend below the elongate platform 102. In another example, the mount 150 may be located proximate the central region 114. In yet another example, the elongate platform 102 may include more than one mount 150.

In still yet another example, a mount 150 may not be required, and the counter weight 148 may be supported by or connected directly to the elongate members 142, 144. In another example, there may not be a mount 150 or a counter weight 148.

As was described above, the lifting beam system is securable to (or suspendable from) a main hoist line 112 that may extend from a lifting device (not shown). Having a single hoist line 112 connected to the lifting beam system 100 may allow for the lifting beam system 100 to be rotated about the hoist line 112.

Referring to FIGS. 3A and 3B, the ability to rotate the lifting beam system 100 about the hoist line 112 may be necessary when the drop-off or pick-up location of an object to be transported is not in-line with the base of the lifting device. For example, consider a scenario where an object needs to be placed into a building 200 through a window 202. By rotating the lifting beam system 100 about the hoist line 112, the lifting beam system can access windows, e.g. window 202a, that are not in-line with the lifting device.

Put another way, without moving the lifting device 204 of FIG. 3B, the lifting beam system 100 can access window 202a and 202b. With a system similar to that described by Barnhart, both windows 202a and 202b may not be accessible from one lifting device position as the lifting beam may not be rotatable and insertable through the window 202, see for example FIG. 3A.

The lifting beam system 100 may be rotated about the hoist line 112 using tethers attached to the elongate platform 102 and drivers for controlling the tethers. In some examples, the drivers may be workers located on the ground or in a nearby building that are able to control the rotation of the lifting beam system by pulling on the tethers.

In other examples, machinery may be used to pull on the tethers. In yet other examples, the block 104, the hook 110, or the main hoist line 112 may be rotatable. For example, a block may have a first portion that connects to the hook and a second portion that connects to the first and second cables extending to the elongate platform, and the first portion may be rotatable relative to the second portion. In such an example tethers may be used to control the rotation, or the block may have an internal motor.

The embodiments herein have been described here by way of example only. Various modification and variations may be made to these exemplary embodiments which is limited only by the appended claims.

1. A lifting beam system securable to a lifting device, comprising:
an elongate platform extending between a first end region and a second end region, the elongate platform connected to a block by a first cable and a second cable;
the block for connecting the lifting beam system to the lifting device;
the first cable extending between the block and a central region of the elongate platform; and
the second cable extending between the block and the first end region of the elongate platform,
wherein a length of the second cable that extends between the block and the elongate platform is adjustable for varying the distance between the block and the first end region of the elongate platform.

2. The lifting beam system of claim 1, wherein the elongate platform comprises a winch for adjusting the length of the second cable that extends between the block and the elongate platform.

3. The lifting beam system of claim 2, wherein the winch is connected to a top surface of the platform.

4. The lifting beam system of claim 3, wherein the elongate platform further comprises a first pulley at the first end region of the elongate platform, the second cable extending between the block and the first pulley and between the first pulley and the winch, wherein the winch is located proximate to the central region of the elongate platform.

5. The lifting beam system of claim 4, wherein the block comprises a block pulley, the second cable extending between the block pulley and the elongate platform.

6. The lifting beam system of claim 5, wherein the elongate platform comprises a second pulley, the second cable extending from the second pulley to the block.

7. The lifting beam system of claim 2, wherein the platform comprises a first elongate platform laterally spaced from a second elongate platform, the first elongate platform connected to the second elongate platform by at least a first removable crosspiece.

8. The lifting beam of claim 7, wherein the lateral space between the first and second members is adjustable.

9. The lifting beam of claim 8, wherein the lateral space between the first and second members is adjustable by exchanging at least one of the at least a first crosspieces with an alternate crosspiece.

10. The lifting beam of claim 9, wherein the winch is connected to one of the at least a first crosspieces.

11. The lifting beam of claim 2, wherein the elongate platform comprises a mount at the first end region for receiving a counter weight, the second cable connecting to the elongate platform between the mount and the central region.

12. The lifting beam of claim 2, wherein the elongate platform comprises a mount at a second end of the elongate platform, the mount for receiving a load.
